(19) United States
(12) Patent Application Publication
(10) Pub. No.: US 2012/0289393 A1
(43) Pub. Date: Nov. 15, 2012

(54) Method for Producing Ulta-Low-Expansion Glass

(75) Inventors: Junichi Kushibiki, Miyagi (JP); Mototaka Arakawa, Miyagi (JP)

(73) Assignee: Tohoku University, Miyagi (JP)

(21) Appl. No.: 13/575,290

(22) PCT Filed: Feb. 24, 2011
(86) PCT No.: PCT/JP2011/054192

§ 371 Date: Jul. 25, 2012

(30) Foreign Application Priority Data
Feb. 24, 2010 (JP) 2010-038388

(51) Int. Cl. C03B 20/00; C03C 3/04

(52) U.S. Cl. 501/53; 65/29.19; 65/29.18

(57) ABSTRACT

A TiO₂—SiO₂ glass ingot having a desired TiO₂ concentration is fabricated, a sample is cut from the TiO₂—SiO₂ glass ingot, OH concentration C(OH), TiO₂ concentration C(TiO₂) and fictive temperature T_{F} of the sample are measured, and zero-CTE temperature T(zero-CTE) is calculated from the measured C(OH), C(TiO₂) and T_{F}. A judgment is made as to whether the difference ΔT between the zero-CTE temperature T(zero-CTE) and a target value is within a predetermined range. When the difference ΔT is within the predetermined range, it is judged that the TiO₂—SiO₂ glass ingot has a desired zero-CTE temperature; when the difference ΔT is not within the range, a production condition for the TiO₂—SiO₂ glass ingot is corrected on the basis of the difference ΔT.

### TECHNICAL FIELD

The present invention relates to a method for producing an ultra-low-expansion glass and, in particular, to a method for producing a TiO₂—SiO₂ ultra-low-expansion glass.

### BACKGROUND ART

There is a demand for ultra-low-expansion glasses that have a coefficient of thermal expansion (CTE) within 0±5 ppb/K at a desired temperature as basic substrate materials of photomask blanks and reflective optics for extreme ultraviolet lithography (EUVL) systems [Non-patent literature 1]. One of the candidates is TiO₂—SiO₂ glass [Non-patent literatures 2 and 3]. Specifications of the temperature at which a coefficient of thermal expansion (CTE) becomes zero, that is, zero-CTE temperature T(zero-CTE), required for mask substrates and mirrors at different stages vary because of high light-source output.

A desired T(zero-CTE) of a TiO₂—SiO₂ glass is obtained by adjusting TiO₂ concentration C(TiO₂) to lie between 6 to 9 wt %. For EUVL applications, it is important to evaluate surface properties. However, conventional CTE measurement methods [Non-patent literatures 4 and 5] do not have sufficiently high measurement accuracy and cannot evaluate substrate surface properties. Based on experiences with the line-focus-beam ultrasonic material characterization (LFB-UMC) system [Non-patent literatures 6 and 7], the present inventors proposed and developed an indirect method by ultrasonic velocity measurement for evaluating CTE characteristics of TiO₂—SiO₂ glasses, using the relationships among the chemical, physical and thermal properties [Non-patent literatures 8 and 9]. The phase velocity (V_{LSAW}) of leaky surface acoustic waves (LSAWs) excited and propagated on a water-loaded specimen surface is measured to perform the evaluation. As compared with a direct method of CTE measurement using a thermal dilatometer, the method and system using ultrasonic velocity measurement have the advantage that two-dimensional distributions of CTE on specimen surfaces can be accurately measured in a nondestructive and noncontact manner at a room temperature without changing the temperature of the specimen. The present inventors have established a procedure to use the system in glass development and mass-production stages. The present inventors also suggested that only this ultrasonic velocity measurement method would enable both glass manufactures and users to inspect all the substrates [Non-patent literature 10]. So far, the present inventors have established the basis of the T(zero-CTE) measurement method for TiO₂—SiO₂ ultra-low-expansion (ULE) glasses [Non-patent literatures 11 to 14] and has successfully prototyped homogeneous TiO₂—SiO₂ ULE glasses [Non-patent literature 15].

In order to evaluate CTE characteristics of glasses by the ultrasonic velocity measurement method, LSAW velocity is measured as one type of ultrasonic velocity. The principle of the measurement is detailed in a literature [Non-patent literature 6].

FIG. 1A is a cross-sectional view of a line-focus-beam device (hereinafter referred to as the LFB device) 10 and a glass specimen 14 having striae 14P, showing the principle of forming a V(z) curve. The LFB device 10 includes an LFB acoustic lens 12 and a ZnO film transducer 11 attached on the top surface of the LFB acoustic lens 12. A radio-frequency pulse provided to the transducer 11 causes the transducer 11 to produce ultrasonic waves, which are then focused in wedge form by the LFB acoustic lens 12 and caused to be incident on the specimen surface 14S through a water coupler. FIG. 1B shows an ultrasonic beam region 15, which is a measurement region W×D on the specimen surface 14S. Here, W is the propagation distance of LSAW on the specimen surface in the focused direction and is given by 2|z|tan θ_{LSAW} (θ_{LSAW} is the critical angle of LSAW, defined as sin⁻¹(V_{W}/V_{LSAW})) and D is an effective beam width in the unfocused direction. Thus, velocity averaged over the measurement region on which LSAWs propagate can be measured. FIG. 2A shows a typical V(z) curve measured for TiO₂—SiO₂ glasses. FIG. 2B shows a spectral distribution obtained by a V(z) curve analysis method [Non-patent literature 6] for the waveform in FIG. 2A. V_{LSAW} can be determined by obtaining the oscillation interval Δz of the V(z) curve and substituting the oscillation interval Δz into the Formula (1).

$${V}_{LSAW} = \frac{{V}_{W}}{\sqrt{1 - {( 1 - \frac{{V}_{W}}{2 f Δ z} )}^{2}}} \qquad ( 1 )$$

Here, V_{W} is the longitudinal-wave velocity in water. The absolute value of V_{LSAW} can be obtained by system calibration using an appropriate standard specimen for TiO₂—SiO₂ ULE glasses. Measurement reproducibilities of V_{LSAW} are within ±0.17 m/s (±0.005%) for ±2σ (σ: standard deviation) at 225 MHz and within ±0.07 m/s (±0.002%) at 75 MHz. With the 225-MHz device, W of the measurement region W×D is 280 μm and D is 900 μm; with the 75-MHz device, W is 750 μm and D is 1.4 mm. Since most of the energy of Rayleigh-type LSAWs is confined within one wavelength below the specimen surface as they propagate, the resolutions in the depth direction are approximately 15 μm at 225 MHz and approximately 44 μm at 75 MHz [Non-patent literature 13].

By replacing the LFB device with a longitudinal-wave device or a shear-wave device, longitudinal-wave velocity or shear-wave velocity can be measured within the frequency range of 10 to 250 MHz by a pulse interference method using double pulses [Non-patent literature 16]. The accuracy of the measurement is estimated to be ±0.03 m/s for ±26 for a 10-mm thick specimen [Non-patent literature 17].

The CTE characteristics are adjusted with C(TiO₂) [wt %] and are in a linear relationship from 0 wt % to 9 wt %. The present inventors previously obtained Formulas (2) and (3) for C(TiO₂) and T(zero-CTE) [° C.], respectively, related to V_{LSAW} [m/s] at 225 MHz [Non-patent literatures 12 and 18].

C(TiO₂)=−0.0669×V_{LSAW}+228.3 (2)

T(zero-CTE)=−2.67×V_{LSAW}+8827 (3)

The sensitivity of T(zero-CTE) determined by LSAW velocity measurement is −2.67° C./(m/s), with a resolution of ±0.4° C. corresponding to measurement reproducibility of ±0.17 m/s. The CTE distributions within ±5 ppb/K required for EUVL-grade ULE glass substrates correspond to LSAW velocity distributions within ±1.15 m/s. A higher resolution in T(zero-CTE) of ±0.2° C. can be achieved by causing the system to operate at 75 MHz.

### PRIOR ART LITERATURE

### Non-Patent Literature

Non-patent literature 1: K. E. Hrdina, B. G Ackerman, A. W. Fanning, C. E. Heckle, D. C. Jenne, and W. D. Navan, “Measuring and tailoring CTE within ULE® glass,” Proc. SPIE, Vol. 5037, pp. 227-235 (2003).
Non-patent literature 2: P. C. Schultz, and H. T. Smyth, Amorphous Materials (Willey-Interscience, New York) pp. 453-461 (1970).
Non-patent literature 3: R. B. Greegor, F. W. Lytle, D. R. Sandstrom, J. Wong, and P. Schultz, “Investigation of TiO₂—SiO₂ glasses by X-ray absorption spectroscopy,” J. Non-Cryst. Solid., Vol. 55, pp. 27-43 (1983).
Non-patent literature 4: V. G Badami and M. Linder, “Ultra-high accuracy measurement of the coefficient of thermal expansion for ultra-low-expansion materials,” Proc. SPIE, Vol. 4688, pp. 469-480 (2002).
Non-patent literature 5: Y. Takeichi, I. Nishiyama, and N. Yamada, “High-precision (<1 ppb/° C.) optical heterodyne interferometric dilatometer for determining absolute CTE of EUVL materials,” Proc. SPIE, Vol. 6151, 61511Z (2006).
Non-patent literature 6: J. Kushibiki and N. Chubachi, “Material characterization by line-focus-beam acoustic microscope,” IEEE Trans. Sonics Ultrason., Vol. SU-32, pp. 189-212 (1985).
Non-patent literature 7: J. Kushibiki, Y. Ono, Y. Ohashi, and M. Arakawa, “Development of the line-focus-beam ultrasonic material characterization system,” IEEE Trans. Ultrason., Ferroelect., Freq. Contr., Vol. 49, pp. 99-113 (2002).
Non-patent literature 8: J. Kushibiki, M. Arakawa, Y. Ohashi, K. Suzuki, and T. Maruyama, “A promising evaluation method of ultra-low-expansion glasses for the extreme ultra-violet lithography system by the line-focus-beam ultrasonic material characterization system,” Jpn. J. Appl. Phys., Vol. 43, pp. L1455-L1457 (2004).
Non-patent literature 9: J. Kushibiki, M. Arakawa, Y. Ohashi, K. Suzuki, and T. Maruyama, “A super-precise CTE evaluation method for ultra-low-expansion glasses using the LFB ultrasonic material characterization system,” Jpn. J. Appl. Phys., Vol. 44, pp. 4374-4380 (2005).
Non-patent literature 10: M. Arakawa, Y. Ohashi, and J. Kushibiki, “Evaluation and selection of EUVL-grade TiO₂—SiO₂ ultra-low-expansion glasses using the line-focus-beam ultrasonic material characterization system,” Proc. SPIE, Vol. 6517, 651725 (2007).
Non-patent literature 11: J. Kushibiki, M. Arakawa, Y. Ohashi, and K. Suzuki, “Evaluation method of TiO₂—SiO₂ultra-low-expansion glasses with periodic striae using the LFB ultrasonic material characterization system,” IEEE Trans. Ultrason., Ferroelect., Freq. Contr., Vol. 53, pp. 1627-1636 (2006).
Non-patent literature 12: M. Arakawa, J. Kushibiki, Y. Ohashi, and K. Suzuki, “Accurate calibration line for super-precise coefficient of thermal expansion evaluation technology of TiO₂-doped SiO₂ ultra-low-expansion glass using the line-focus-beam ultrasonic material characterization system,” Jpn. J. Appl. Phys., Vol. 45, pp. 4511-4515 (2006).
Non-patent literature 13: Y. Ohashi, M. Arakawa, and J. Kushibiki, “Improvement of velocity measurement accuracy of leaky surface acoustic waves for materials with highly attenuated waveform of the V(z) curve by the line-focus-beam ultrasonic material characterization system,” Jpn. J. Appl. Phys., Vol. 45, pp. 4505-4510 (2006).
Non-patent literature 14: Y. Ohashi, J. Kushibiki, M. Arakawa, and K. Suzuki, “Experimental study for evaluating striae structure of TiO₂—SiO₂ glasses using the line-focus-beam ultrasonic material characterization system,” Jpn. J. Appl. Phys., Vol. 45, pp. 6445-6451 (2006). Non-patent literature 15: J. Kushibiki, M. Arakawa, T. Ueda, and A. Fujinoki, “Homogeneous TiO₂—SiO₂ultra-low-expansion glass for extreme ultraviolet lithography evaluated by the line-focus-beam ultrasonic material characterization system,” Appl. Phys. Express, Vol. 1, 087002 (2008).
Non-patent literature 16: J. Kushibiki, and M. Arakawa, “Diffraction effects on bulk-wave ultrasonic velocity and attenuation measurements,” J. Acoust. Soc. Am., Vol. 108, pp. 564-573 (2000).
Non-patent literature 17: J. Kushibiki, M. Arakawa, and R. Okabe, “High-accuracy standard specimens for the line-focus-beam ultrasonic material characterization system,” IEEE Trans. Ultrason., Ferroelect., Freq. Contr., Vol. 49, pp. 827-835 (2002).
Non-patent literature 18: J. Kushibiki and M. Arakawa, “Precise evaluation of zero-CTE temperature of EUVL-grade TiO₂—SiO₂ ultra-low-expansion glass using the line-focus-beam ultrasonic material characterization system,” Proc. SPIE, Vol. 7271, 71713D (2009).

### DISCLOSURE OF THE INVENTION

### Problem to be Solved by the Invention

According to the method described above, T(zero-CTE) of glass can be determined by measuring V_{LSAW} and therefore a TiO₂ concentration for obtaining a desired T(zero-CTE) can be decided. However, there has been a problem that, conversely, the method has a low degree of flexibility of control because TiO₂ concentration is the only parameter that changes T(zero-CTE). Accordingly, the degree of flexibility of feedback to production based on evaluations is low, which has made the production difficult correspondingly. There is another problem that Formulas (2) and (3) cannot be applied because proper measurement cannot be accomplished on glasses that are subjected to heat treatment under different conditions.

An object of the present invention is to solve these problems to provide a method for producing TiO₂—SiO₂ ultra-low-expansion glasses that has a high degree of flexibility of control for achieving a desired T(zero-CTE), is capable of proper measurement regardless of heat treatment conditions and readily providing feedback to production of a glass having a desired T(zero-CTE) on the basis of the measurement.

### Means to Solve the Problems

A method for producing an ultra-low-expansion glass according to the present invention includes the steps of:

(a) fabricating a TiO₂—SiO₂ glass ingot having a selected TiO₂ concentration;

(b) cutting a sample from the TiO₂—SiO₂ glass ingot and measuring OH concentration C(OH), TiO₂ concentration C(TiO₂) and fictive temperature T_{F};

(c) calculating zero-CTE (coefficient of thermal expansion) temperature T(zero-CTE) from the measured C(OH), C(TiO₂) and T_{F};

(d) judging whether a difference ΔT between the T(zero-CTE) and a predetermined target value is within a predetermined acceptable range and, when the difference ΔT is within the acceptable range, judging that the TiO₂—SiO₂ glass ingot has a desired zero-CTE temperature; and

(e) when the difference ΔT is not within the acceptable range in the step (d), correcting a fabrication condition for the TiO₂—SiO₂ glass ingot on the basis of the difference ΔT from the target value.

### Effects of the Invention

According to the present invention, a high degree of flexibility of T(zero-CTE) control can be achieved, production is facilitated, and T(zero-CTE) for samples having different fictive temperatures T_{F} can be controlled, because not only TiO₂ concentration C(TiO₂) but also fictive temperature T_{F} and C(OH) are calculated as factors that affect T(zero-CTE).

### BRIEF DESCRIPTION OF THE DRAWINGS

FIG. 1A is a cross-sectional view of an LFB ultrasonic device, illustrating a principle of V(z) curve measurement;

FIG. 1B is a graph showing a measurement region of LFB in a defocus distance;

FIG. 2A is a typical V(z) curve measured for the TiO₂—SiO₂ glass specimen at 225 MHz;

FIG. 2B is a graph of a spectral distribution obtained by analysis of the V(z) curve by FFT;

FIG. 3A is a graph of a relationship between LSAW velocity and longitudinal-wave velocity for the TiO₂—SiO₂ glass;

FIG. 3B is a graph of a relationship between LSAW velocity and shear-wave velocity for the TiO₂—SiO₂ glass;

FIG. 3C is a graph of a relationship between LSAW velocity and density for the TiO₂—SiO₂ glass;

FIG. 4 is a graph of a relationship between LSAW velocity and TiO₂ concentration for the TiO₂—SiO₂ glass;

FIG. 5 is a graph of relationships among LSAW velocity, zero-CTE temperature, and CTE at 23° C. for the TiO₂—SiO₂ glass;

FIG. 6 is Table 1 showing sensitivities and resolutions for the variation of parameters;

FIG. 7A is graph of a relationship between heat treatment temperature and longitudinal-wave velocity for the SiO₂ glass;

FIG. 7B is a graph of a relationship between heat treatment temperature and shear-wave velocity for the SiO₂ glass;

FIG. 7C is a graph of a relationship between heat treatment temperature and LSAW velocity for the SiO₂ glass;

FIG. 7D is a graph of a relationship between heat treatment temperature and density for the SiO₂ glass;

FIG. 7E is a graph of a relationship between heat treatment temperature and CTE at 23° C. for the SiO₂ glass;

FIG. 8A is a graph of a relationship between longitudinal-wave velocity and shear-wave velocity for the SiO₂ glass;

FIG. 8B is a graph of a relationship between longitudinal-wave velocity and LSAW velocity for the SiO₂ glass;

FIG. 8C is a graph of a relationship between longitudinal-wave velocity and density;

FIG. 8D is a graph of a relationship between longitudinal-wave velocity and CTE at 23° C. for the SiO₂ glass;

FIG. 9A is a graph of a relationship between fictive temperature and longitudinal-wave velocity for the SiO₂ glass;

FIG. 9B is a graph of a relationship between fictive temperature and shear-wave velocity for the SiO₂ glass;

FIG. 9C is a graph of a relationship between fictive temperature and LSAW velocity for the SiO₂ glass;

FIG. 9D is a graph of a relationship between fictive temperature and density for the SiO₂ glass;

FIG. 9E is a graph of a relationship between fictive temperature and CTE at 23° C. for the SiO₂ glass;

FIG. 10 is Table 2 showing sensitivities and resolutions of acoustic properties to fictive temperature for the SiO₂ glass;

FIG. 11A is a graph of a relationship between fictive temperature and longitudinal-wave velocity for a TiO₂—SiO₂ glass;

FIG. 11B is a graph of a relationship between fictive temperature and shear-wave velocity for a TiO₂—SiO₂ glass;

FIG. 11C is a graph of a relationship between fictive temperature and LSAW velocity for a TiO₂—SiO₂ glass;

FIG. 11D is a graph of a relationship between fictive temperature and density for a TiO₂—SiO₂ glass;

FIG. 11E is a graph of a relationship between fictive temperature and zero-CTE temperature for a TiO₂—SiO₂ glass;

FIG. 11F is a graph of a relationship between fictive temperature and CTE at 23° C. for a TiO₂—SiO₂ glass;

FIG. 12 is Table 3 showing sensitivities and resolutions of acoustic properties to fictive temperature for a TiO₂—SiO₂ glass;

FIG. 13 is Table 4 showing sensitivities and resolutions of acoustic properties to changes in T(zero-CTE) for the TiO₂—SiO₂ glass;

FIG. 14A is a graph of a relationship of ΔV_{L}/ΔC(OH) to fictive temperature;

FIG. 14B is a graph of a relationship of ΔV_{S}/ΔC(OH) to fictive temperature;

FIG. 14C is a graph of a relationship of ΔV_{LSAW}/ΔC(OH) to fictive temperature;

FIG. 14D is a graph of a relationship of Δρ/ΔC(OH) to fictive temperature;

FIG. 14E is a graph of a relationship of ΔT(zero-CTE)/ΔC(OH) to fictive temperature;

FIG. 14F is a graph of a relationship of ΔCTE/ΔC(OH) to fictive temperature;

FIG. 15A is a graph of a relationship of T(zero-CTE) to LSAW velocity for a TiO₂—SiO₂ glass with C(OH)=1000 wtppm;

FIG. 15B is a graph of a relationship of T(zero-CTE) to longitudinal-wave velocity for a TiO₂—SiO₂ glass with C(OH)=1000 wtppm;

FIG. 16A is a graph of a relationship of T(zero-CTE) to LSAW velocity for a TiO₂—SiO₂ glass with C(OH)=100 wtppm;

FIG. 16B is a graph of a relationship of T(zero-CTE) to longitudinal-wave velocity for a TiO₂—SiO₂ glass with C(OH)=100 wtppm; and

FIG. 17 is a diagram showing a process flow of a production/evaluation method.

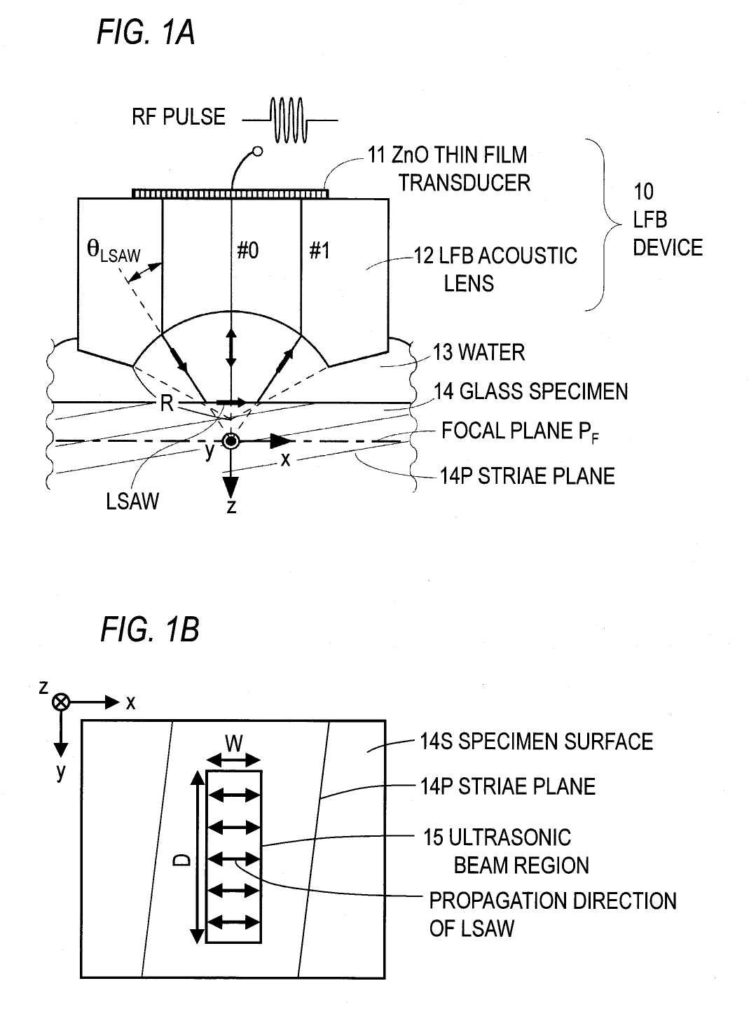

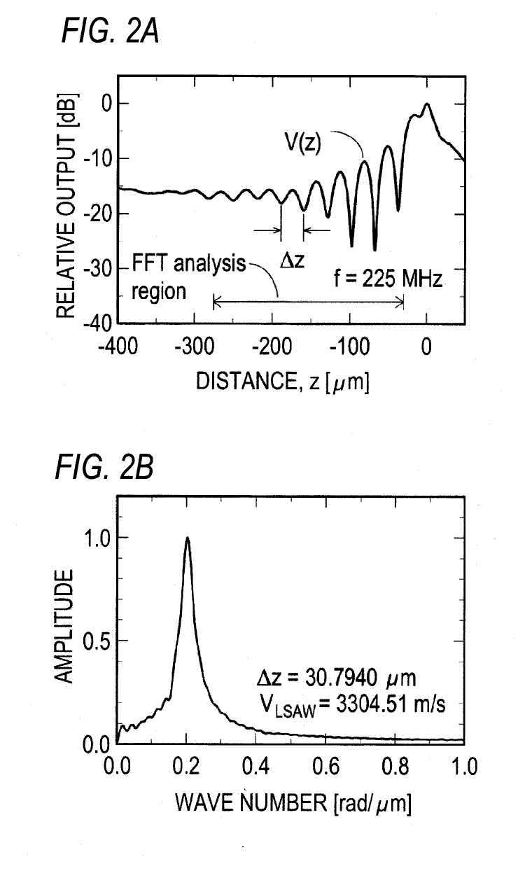

### DETAILED DESCRIPTION OF THE EMBODIMENTS

[Preparation of Calibration Lines]

CTE (coefficient of thermal expansion) characteristics of TiO₂—SiO₂ ultra-low-expansion glass are adjusted by TiO₂ concentration. OH (hydroxyl) content, contained depending on a fabrication process, and thermal history (fictive temperature T_{F}) of glass also have considerable influence on CTE characteristics. Therefore, relationships of CTE characteristics (especially zero-CTE temperature {T(zero-CTE)} at which CTE becomes zero) to chemical composition ratio (TiO₂ concentration C(TiO₂)), impurity (OH) concentration C(OH), and fictive temperature were studied by using acoustic properties (leaky-surface-acoustic-wave (LSAW) velocity V_{LSAW}, longitudinal-wave velocity V_{L}, shear-wave velocity V_{S}, and density ρ) measured by an ultrasonic microspectroscopy (UMS) technique.

To study the influences of TiO₂ concentration, fictive temperature and OH concentration on zero-CTE temperature and acoustic properties, specimens of the following four types of glass were prepared.

Direct-synthesis method of TiO₂—SiO₂ ultra-low-expansion glass (C-7972, manufactured by and commercially available from Corning, Incorporated)
With a C(OH) of approximately 1000 wtppm

Soot method of TiO₂—SiO₂ ultra-low-expansion glass (prototype)
With a C(OH) of approximately 100 wtppm

Direct-synthesis method of SiO₂ glass (C-7980, manufactured by and commercially available from Corning Incorporated)
With a C(OH) of approximately 1000 wtppm

Soot method of SiO₂ glass (ED-B, manufactured by and commercially available from Tosoh Quartz Corp.)
With a C(OH) of 0 wtppm

To study the influence of fictive temperature, specimens having different fictive temperatures were fabricated by heat treatment at different temperatures in a high-temperature electric furnace.

### (a) Influence of TiO₂ Concentration

Specimens were prepared from C-7972 ingots in a plurality of different lots. Both surfaces of the specimens were optically polished. In addition, a C-7980 specimen with a TiO₂ concentration of zero was prepared.

The OH concentrations of the specimens prepared were measured by infrared spectroscopy [Reference literature 1]. Fictive temperatures were measured from relationships among longitudinal-wave velocity, LSAW velocity, and zero-CTE temperature. As a result, the OH concentrations were 975±15 wtppm and the fictive temperatures were 873±7° C. The accuracies of the measurements are ±1 wtppm and ±1° C. Therefore, the specimens C-7972 and C-7980 used in the measurements can be treated as specimens with a constant OH concentrations and fictive temperatures.

First, the longitudinal-wave velocities V_{L} (m/s), shear-wave velocities V_{S} (m/s), densities ρ (kg/m³), and LSAW velocities V_{LSAW} (m/s) of the specimens were measured. The LSAW velocities were measured with a line-focus-beam ultrasonic material characterization (LFB-UMC) system [Non-patent literature 7] at an ultrasonic frequency f of 225 MHz. The principle of the LSAW velocity measurement is detailed in Non-patent literature 6. The longitudinal-wave velocity and the shear-wave velocity were measured by replacing the LFB ultrasonic device with a plane-wave ultrasonic device and using a complex-mode measurement method that uses RF burst signals [Non-patent literature 16]. The density was measured on the basis of the Archimedes principle [Reference literature 2].

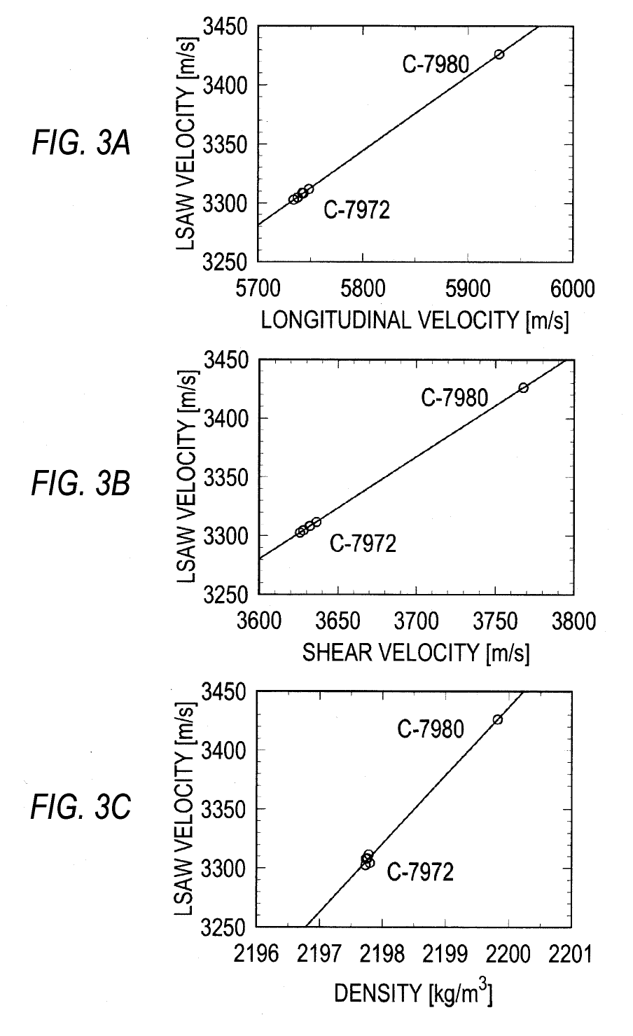

FIG. 3 show the results of the measurements. FIG. 3A shows a relationship between LSAW velocity and longitudinal-wave velocity, FIG. 3B shows a relationship between LSAW velocity and shear-wave velocity, and FIG. 3C shows a relationship between LSAW velocity and density. It can be seen that the acoustic properties are in a linear relationship with one another. As a result, the following Formulas were obtained for C-7972.

V_{LSAW}=0.6325×V_{L}−324.01 (4)

V_{LSAW}=57.85×ρ−123838.8 (5)

V_{LSAW}=0.8686×V_{S}+153.26 (6)

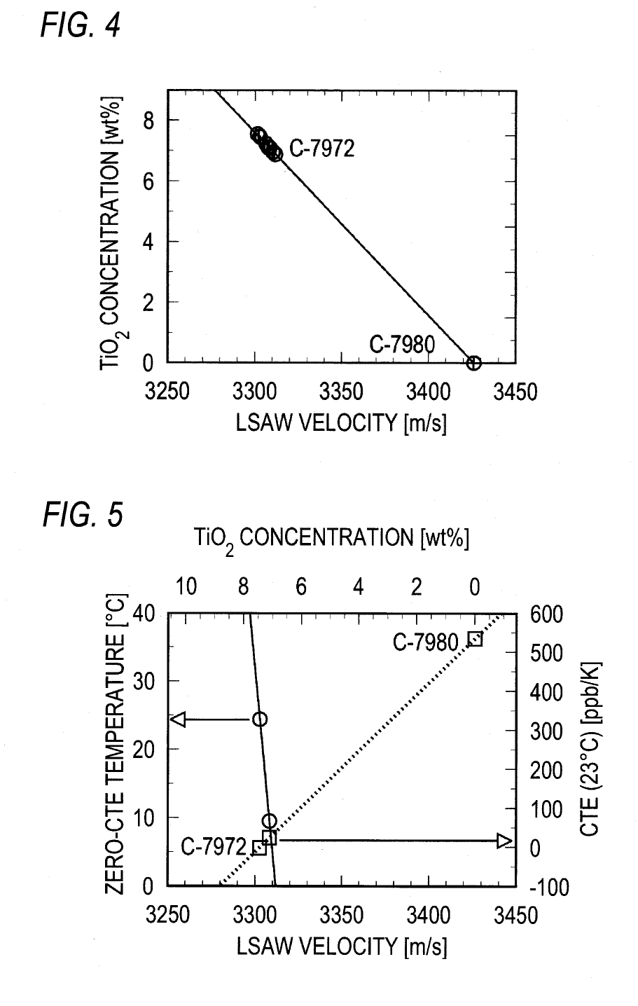

Then, the relationship between TiO₂ concentration and LSAW velocity was studied. TiO₂ concentration was measured by X-ray fluorescence analysis (XRF) method. Since values measured by the XRF method vary depending on the system used and measurement conditions, calibration is performed with specimens used for obtaining the relationship by XRF method and inductively-coupled plasma optical emission spectrometry (ICP-OES) [Non-patent literature 12]. FIG. 4 shows the results of the measurements. As a result, the following Formula was obtained.

C(TiO₂)=−0.0602×V_{LSAW}+206.3 (7)

Then, CTE of each of C-7972 (two types) and C-7980 was measured with an optical heterodyne thermal dilatometer [Reference literature 3] at every 5° C. in the range of 5 to 35° C. FIG. 5 shows relationships among LSAW velocity, zero-CTE temperature, and CTE at 23° C. {CTE(23° C.) [ppb/K]}. The following Formulas were obtained from the results.

T(zero-CTE)=−2.67×V_{LSAW}+8827 (8)

CTE(23° C.)=4.33×V_{LSAW}−14310 (9)

Because all of Formulas (4) to (9) include V_{LSAW}, TiO₂ concentration can be related to the properties through V_{LSAW} as follows;

V_{LSAW}=−16.61×C(TiO₂)+3426.1 (10)

V_{L}=−26.26×C(TiO₂)+5929.0 (11)

V_{S}=−19.07×C(TiO₂)+3767.5 (12)

ρ=−0.287×C(TiO₂)+2199.8 (13)

T(zero-CTE)=44.27×C(TiO₂)−304.8 (14)

CTE(23° C.)=−71.95×C(TiO₂)+533.7 (15)

Furthermore, zero-CTE temperature can be related to the acoustic properties as follows:

T(zero-CTE)=−1.69×V_{L}+9691 (16)

T(zero-CTE)=−2.32×V_{S}+8441 (17)

T(zero-CTE)=−154.2×ρ+338916.5 (18)

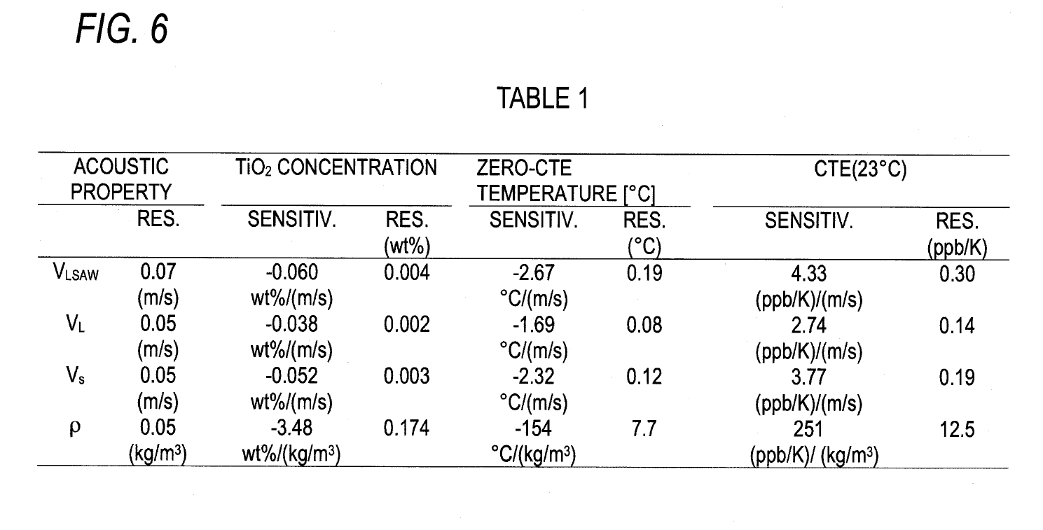

Table 1 in FIG. 6 shows sensitivities and resolutions of the acoustic properties to TiO₂ concentration and CTE characteristics. It can be seen that the velocities (LSAW velocity, longitudinal-wave velocity, and shear-wave velocity) all have high resolutions to the TiO₂ concentration and the zero-CTE temperature.

(b) Influence of Fictive Temperature T_{F}

Then, influence of fictive temperature was studied. SiO₂ glass, which is the basis for TiO₂—SiO₂ glass, will be studied first and then TiO₂—SiO₂ glass will be studied.

(b-1) SiO₂ Glass

Specimens were provided from ED-B fabricated by the soot method and C-7980 fabricated by the direct-synthesis method. ED-B has an OH concentration of 0 wtppm whereas C-7980 has an OH concentration of approximately 1000 wtppm.

In consideration of characteristic temperatures (the strain point and annealing point) of the glasses, ED-B was subjected to heat treatment at temperatures in the range of 1050° C. to 1200° C. and C-7980 was subjected to heat treatment at temperatures in the range of 900° C. to 1100° C. to fabricate specimens having different fictive temperatures.

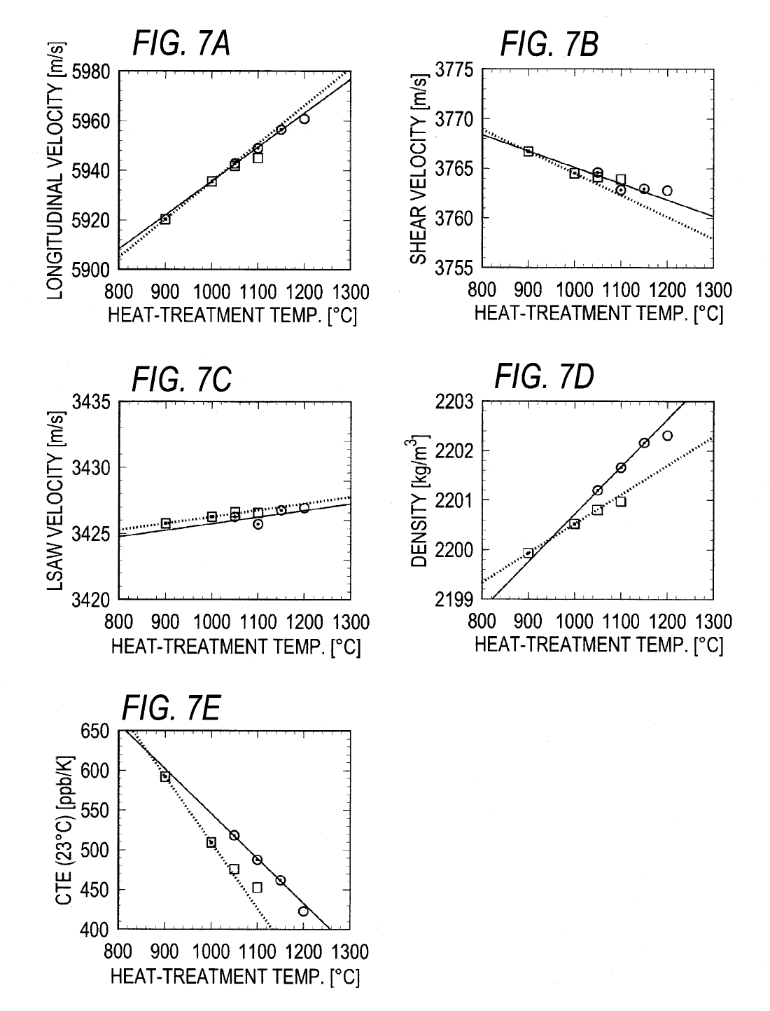

The longitudinal-wave velocities, shear-wave velocities, densities, LSAW velocities, and CTE characteristics of the fabricated specimens were measured. FIG. 7 show the results of the measurements as a function of heat treatment temperature T_{A} corresponding to fictive temperature. FIG. 7A shows longitudinal-wave velocity versus heat treatment temperature; FIG. 7B shows shear-wave velocity versus heat treatment temperature; FIG. 7C shows LSAW velocity versus heat treatment temperature; FIG. 7D shows density versus heat treatment temperature; and FIG. 7E shows CTE(23° C.) versus heat treatment temperature. Approximation lines were drawn with data at 1050° C., 1100° C. and 1150° C. for ED-B and data at 900° C. and 1000° C. for C-7980.

As the heat treatment temperature T_{A} increases, the longitudinal-wave velocity and the density increase and the shear-wave velocity and CTE at 23° C. decrease. Since LSAW, which is mainly a shear-wave particle displacement, is a mode in which longitudinal and shear waves are both combined, the properties of each wave canceled each other to reduce changes in velocity.

It has been reported that the density of SiO₂ glass increases as fictive temperature increases [Reference literatures 4, 5 and 6]. Therefore, changes in the acoustic properties and CTE characteristics reflect changes in fictive temperature.

The longitudinal-wave velocities and the densities in ED-B at T_{A}=1200° C. and in C-7980 at T_{A}=1050° C. and 1100° C. decreased below the values on the approximation lines. It is considered that this is because relaxation time (the time T when relaxation phenomenon occurs in the form of e^{-t/τ} with respect to time t) was reduced due to high temperature to decrease the fictive temperature below the heat treatment temperature.

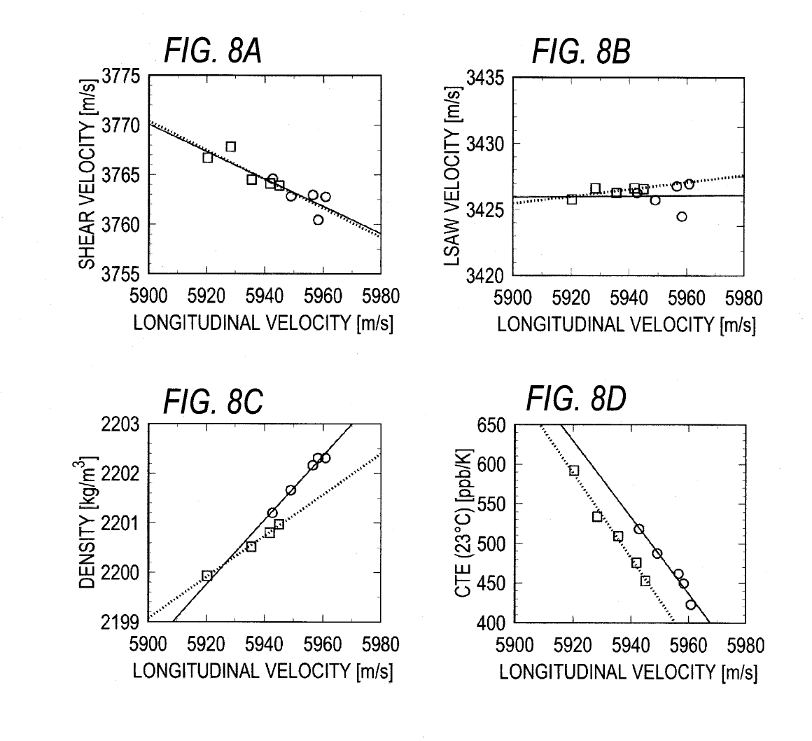

The longitudinal-wave velocity has the highest resolution to the heat treatment temperature T_{A}. Considering the measured value of longitudinal-wave velocity as reflecting the fictive temperature, other properties were plotted as a function of the longitudinal-wave velocity as shown in FIG. 8. Here, the data, including the data that are nonlinear in FIG. 7, are highly linear, because the properties reflect the change in the fictive temperature.

Therefore, assuming that the heat treatment temperatures are equal to the fictive temperatures on the approximation lines in FIG. 7, the fictive temperatures T_{F} [° C.] for ED-B and C-7980 can be determined from Formulas (19) and (20), respectively:

T_{F}=(V_{L}−5798.6)/0.1371 (19)

T_{F}=(V_{L}−5782.9)/0.1527 (20)

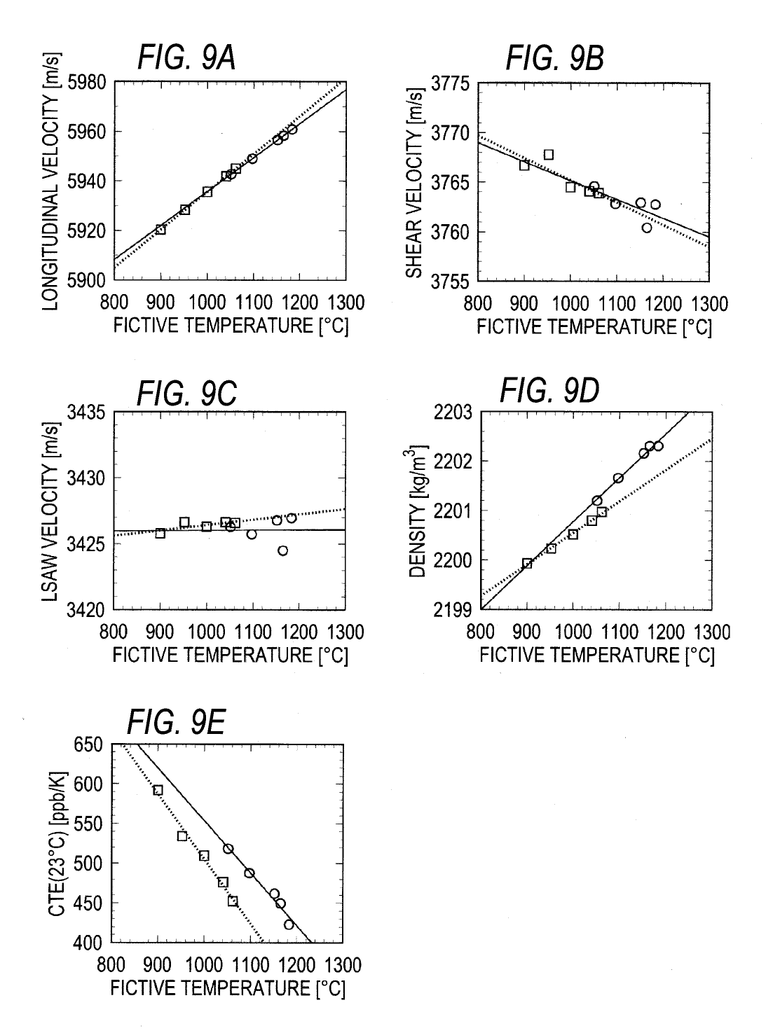

FIG. 9 show the results illustrating the properties versus the fictive temperatures calculated from Formulas (19) and (20) using the results shown in FIG. 8. FIGS. 9A to 9E show the longitudinal-wave velocity, the shear-wave velocity, the LSAW velocity, the density and the CTE at 23° C., respectively, versus the fictive temperature T_{F} determined from the longitudinal-wave velocity V_{L}. It can be seen from the results that all of the properties linearly change with the fictive temperature in this temperature range.

For ED-B, the following Formulas were obtained.

V_{L}=0.1371×T_{F}+5798.62 (21)

V_{S}=−0.0190×T_{F}+3784.07 (22)

V_{LSAW}=0.0002×T_{F}+3425.76 (23)

ρ=0.0089×T_{F}+2191.87 (24)

CTE(23° C.)=−0.661×T_{F}+1214.3 (25)

For C-7980, the following Formulas were obtained.

V_{L}=0.1527×T_{F}+5782.90 (26)

V_{S}=−0.0224×T_{F}+3787.61 (27)

V_{LSAW}=0.0041×T_{F}+3422.33 (28)

ρ=0.0064×T_{F}+2194.16 (29)

CTE(23° C.)=−0.817×T_{F}+1322.5 (30)

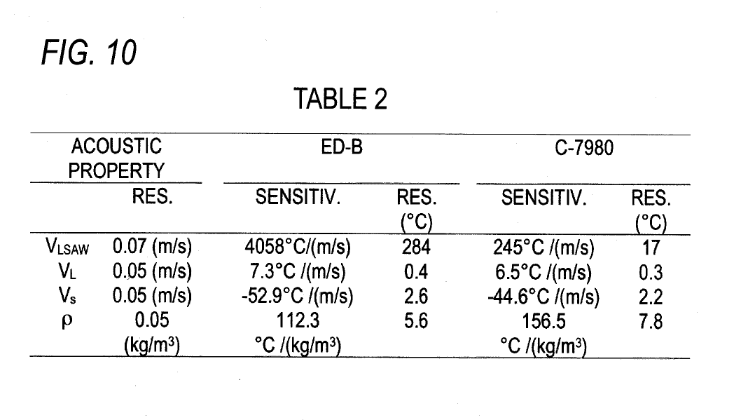

Table 2 in FIG. 10 shows the sensitivities and resolutions of the acoustic properties to fictive temperature. It can be seen from the results that the resolution of the longitudinal-wave velocity to the fictive temperature is as high as 0.3 to 0.4° C. Conventionally, fictive temperature is evaluated by infrared spectroscopy or Raman spectroscopy, resolutions of which are ±15° C. [Reference literature 7] and ±60° C. [Reference literature 8], respectively. The resolutions of longitudinal-wave velocity are 40 to 150 times higher than the conventional methods and therefore are a considerably useful as an evaluation method of fictive temperature.

(b-2) TiO₂—SiO₂ Ultra-Low-Expansion Glass

Specimens were prepared from glass ingots [Non-patent literature 15] produced by using a zone-melting method to homogenize TiO₂—SiO₂ glass fabricated by the soot method and obtained from a commercially available C-7972. The OH concentration of the soot-method specimens was 90 wtppm and the OH concentration of the C-7972 specimens was 953 wtppm. It is assumed here that the OH concentrations of the specimens used do not change.

To determine the dependence of acoustic properties and CTE characteristics on fictive temperature, the soot-method specimen was subjected to heat treatment at temperatures of 950° C. to 1100° C. and C-7972 was subjected to heat treatment at temperatures of 900° to 1100° C., as with the case of the SiO₂ glasses.

An analysis of TiO₂ concentrations by the XRF method showed that C-7972 had 7.02 to 7.14 wt % and the soot-method specimen had 7.32 to 7.36 wt %. To study the influence of the fictive temperature under the same TiO₂ concentration condition, Formulas (10) to (15) were used to correct the acoustic properties and CTE characteristics to values for 7.00 wt %. As with the case of the SiO₂ glasses, approximation lines were drawn for longitudinal-wave velocity data at 950° C. and 1000° C. for the soot-method specimens and 900° C. and 970° C. for the C-7972 specimens. Assuming that the heat treatment temperatures are equal to the fictive temperatures on the approximation lines, the fictive temperatures T_{F} for the soot-method and C-7972 specimens can be determined from Formulas (31) and (32), respectively:

T_{F}=(V_{L}−5646.85)/0.1188 (31)

T_{F}=(V_{L}−5625.28)/0.1364 (32)

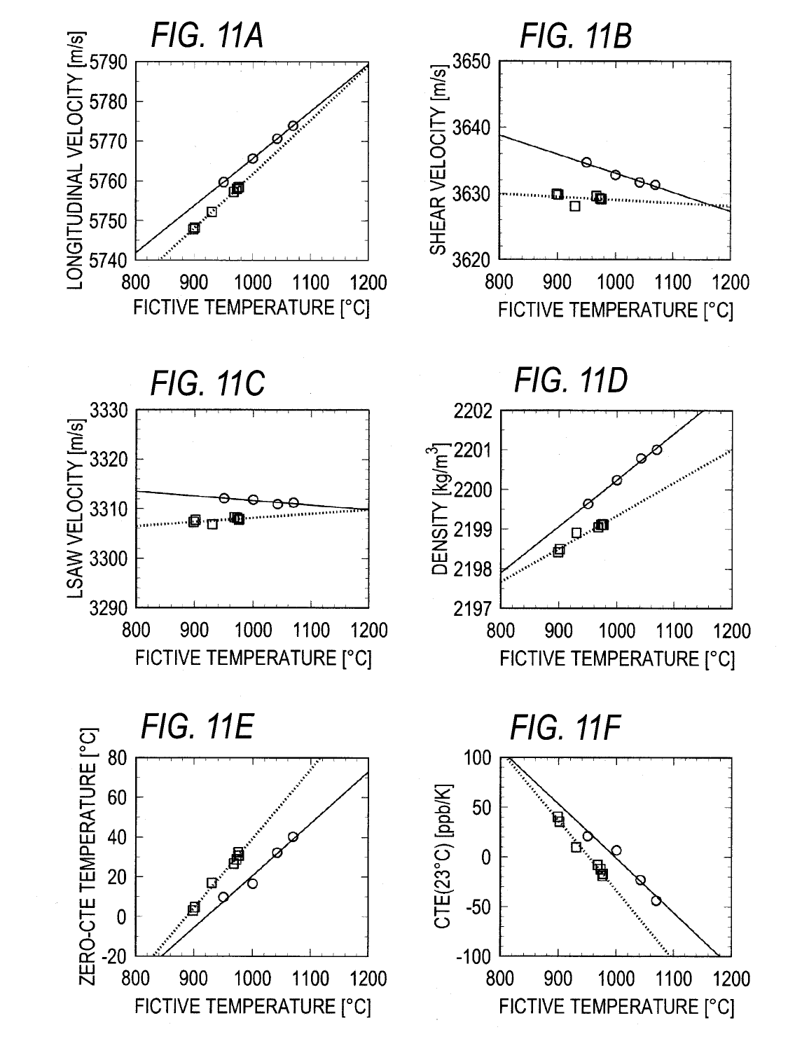

FIG. 11 show the results illustrating the properties versus the fictive temperatures. FIGS. 11A to 11F show the longitudinal-wave velocity, the shear-wave velocity, the LSAW velocity, the density, the zero-CTE temperature, and the CTE at 23° C., respectively, versus the fictive temperature determined from the longitudinal-wave velocity. It can be seen from the results that all of the properties linearly change with the fictive temperature in this temperature range. For the soot-method specimens, the following Formulas were obtained.

V_{L}=0.1188×T_{F}+5646.85 (33)

V_{S}=−0.0286×T_{F}+3661.71 (34)

V_{LSAW}=−0.0091×T_{F}+3320.79 (35)

ρ=0.0117×T_{F}+2188.52 (36)

T(zero-CTE)=0.26×T_{F}−241.4 (37)

CTE(23° C.)=−0.55×T_{F}+544.4 (38)

The following relational expressions were obtained for the C-7972 specimens.

V_{L}=0.1364×T_{F}+5625.28 (39)

V_{S}=−0.0046×T_{F}+3633.60 (40)

V_{LSAW}=0.0084×T_{F}+3299.75 (41)

ρ=0.0083×T_{F}+2191.00 (42)

T(zero-CTE)=0.35×T_{F}−309.4 (43)

CTE(23° C.)=−0.70×T_{F}+668.6 (44)

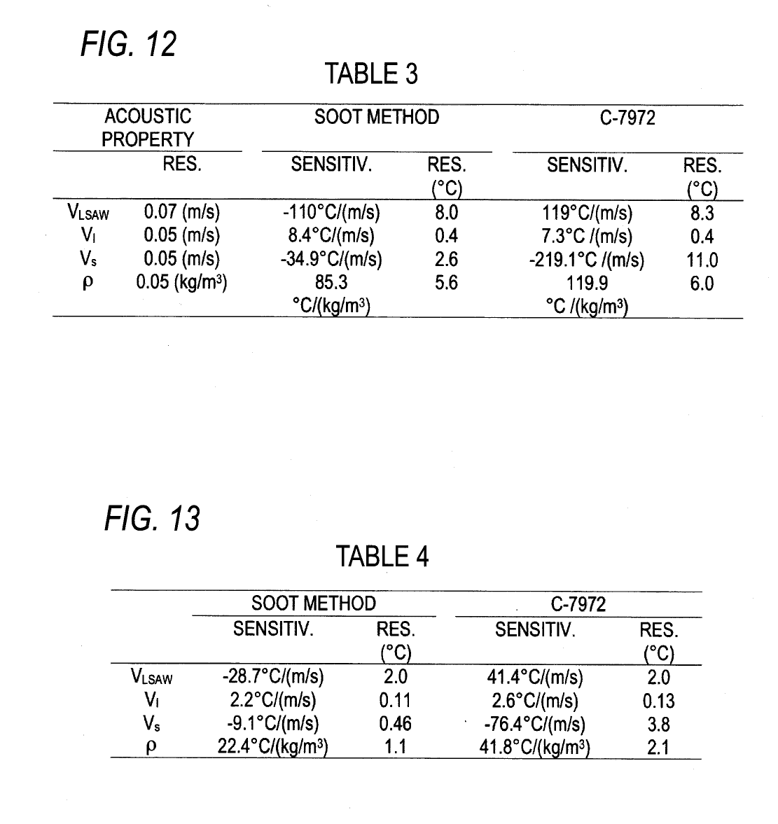

Table 3 in FIG. 12 shows the sensitivities and resolutions of the acoustic properties to fictive temperature. It can be seen from the results that for the TiO₂—SiO₂ glasses, the longitudinal-wave velocity has a resolution to the fictive temperature as high as 0.4° C. and therefore is considerably useful as an evaluation method of the fictive temperature.

From Formulas (33) to (38) and Formulas (39) to (44), the following relational expressions hold between the zero-CTE temperature and the acoustic properties.

### Soot-Method Specimens

T(zero-CTE)=2.20×V_{L}−12700 (45)

T(zero-CTE)=−9.15×V_{S}+33258 (46)

T(zero-CTE)=−28.72×V_{LSAW}+95138 (47)

T(zero-CTE)=22.37×ρ−49195 (48)

### C-7972 Specimens

T(zero-CTE)=2.56×V_{L}−14688 (49)

T(zero-CTE)=−76.4×V_{S}+277253 (50)

T(zero-CTE)=41.4×V_{LSAW}−136939 (51)

T(zero-CTE)=41.8×ρ−91893 (52)

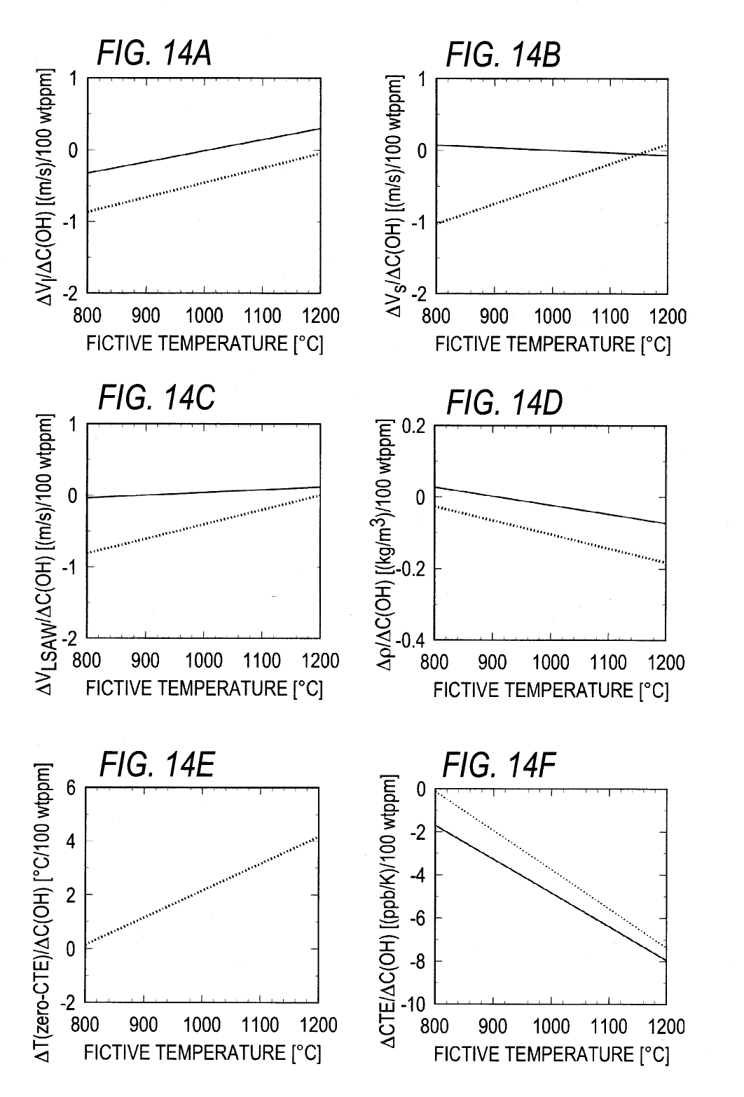

Table 4 in FIG. 13 shows the sensitivities and resolutions of the acoustic properties to changes in zero-CTE temperature due to changes in fictive temperature. It can be seen that in this case the longitudinal-wave velocity has a considerably high resolution to the zero-CTE temperature. On the other hand, the LSAW velocity has a resolution approximately 20 times lower than the longitudinal-wave velocity.

(c) Influence of OH Concentration

The difference between ED-B specimens {C(OH):0 wtppm}, which does not contain TiO₂, and C-7980 specimens {C(OH):1000 wtppm} in FIG. 9 and the difference between the soot-method specimens {C(OH):90 wtppm} and C-7972 specimens {C(OH):953 wtppm}, having the same TiO₂ concentration, in FIG. 11 are due to the influence of the OH concentrations on the acoustic properties and the CTE characteristics of the SiO₂ glass and TiO₂—SiO₂ glass, respectively. Changes in the acoustic properties and the CTE characteristics with changes in the OH concentration per 100 wtppm for the SiO₂ glass and the TiO₂—SiO₂ glass were obtained as fictive temperature dependences. The results are shown in FIG. 14. FIGS. 14A to 14F show the longitudinal-wave velocity, the shear-wave velocity, the LSAW velocity, the density, the zero-CTE temperature, and the CTE at 23° C., respectively, versus the fictive temperature determined from the longitudinal-wave velocity. The solid lines are for the SiO₂ glass and the dotted lines are for the TiO₂—SiO₂ glass. From FIG. 14, the following Formulas can be obtained for the SiO₂ glass and the TiO₂—SiO₂ glass.

### SiO₂ Glass

ΔV_{L}/ΔC(OH)=1.56×10⁻³×T_{F}−1.57 (53)

ΔV_{S}/ΔC(OH)=−0.35×10⁻³×T_{F}+0.35 (54)

ΔV_{LSAW}/ΔC(OH)=0.38×10⁻³×T_{F}−0.34 (55)

Δρ/ΔC(OH)=−0.25×10⁻³×T_{F}+0.23 (56)

ΔCTE(23° C.)/ΔC(OH)=−15.7×10⁻³×T_{F}+10.8 (57)

### TiO₂—SiO₂ Glass

ΔV_{L}/ΔC(OH)=2.04×10⁻³×T_{F}−2.50 (58)

ΔV_{S}/ΔC(OH)=2.79×10⁻³×T_{F}−3.26 (59)

ΔV_{LSAW}/ΔC(OH)=2.03×10⁻³×T_{F}−2.44 (60)

Δρ/ΔC(OH)=−0.39×10⁻³×T_{F}+0.29 (61)

ΔT(zero-CTE)/ΔC(OH)=10.0×10⁻³×T_{F}−7.9 (62)

ΔCTE(23° C.)/ΔC(OH)=−18.1×10⁻³×T_{F}+14.4 (63)

The OH concentration dependence of the acoustic properties and the CTE characteristics are dependent on the fictive temperature. Furthermore, it was shown that the dependence (that is, the absolute value of the T_{F} coefficient in Formulas (53) to (63)) for the TiO₂—SiO₂ glass is higher than that for the SiO₂ glass.

[Control Parameters for Production]

The following is clear from (a), (b) and (c) given above. The zero-CTE temperature T(zero-CTE) of the TiO₂—SiO₂ glass is dependent on parameters such as the TiO₂ concentration C(TiO₂), the OH concentration C(OH), and the fictive temperature T_{F} (the temperature at which the glass structure is frozen). The acoustic properties AP (LSAW velocity V_{LSAW}, longitudinal-wave velocity V_{L}, shear-wave velocity V_{S}, and density ρ) are also dependent on C(TiO₂), C(OH), and T_{F}. Accordingly, the relationships among the parameters can be represented by the following Formulas:

T(zero-CTE)=f{C(TiO₂),C(OH),T_{F}} (64)

ΔP=f{C(TiO₂),C(OH),T_{F}} (65)

Therefore, by measuring the acoustic properties, T(zero-CTE) can be evaluated through C(TiO₂), C(OH) and T_{F}.

As can be seen from Formulas (21) to (30) and Formulas (33) to (44), the dependences of the acoustic properties and the CTE characteristics on the fictive temperature vary depending on the TiO₂ concentration and the OH concentration. Furthermore, as can be seen from Formulas (53) to (63), the OH concentration dependences of them vary depending on the TiO₂ concentration and the fictive temperature. However, the OH concentration is determined by the production process used for fabricating the glass and the TiO₂ concentration and the fictive temperature are determined by a required zero-CTE temperature specification and the heat treatment process. Therefore, a relationship that holds near required specifications (TiO₂ concentration, fictive temperature and OH concentration) may simply be derived from the Formulas given above.

For example, in the case of the direct-method TiO₂—SiO₂ glass (C(TiO₂)=approximately 7 wt %, T_{F}=approximately 870° C., and C(OH)=approximately 1000 wtppm), V_{L}, V_{LSAW}, and T(zero-CTE) are linearly related to C(TiO₂) from Formulas (11), (10) and (14), V_{L}, V_{LSAW} and T(zero-CTE) are linearly related to T_{F} from Formulas (39), (41) and (43) and, if T_{F} is constant, V_{L}, V_{LSAW} and T(zero-CTE) are further linearly related to C(OH) from Formulas (58), (60) and (62). Therefore, by linearly combining these Formulas, the following relational expressions can be produced:

V_{L}=−26.26×C(TiO₂)+0.1364×T_{F}−0.70×C(OH)+5815.8 (66)

V_{LSAW}=−16.61×C(TiO₂)+0.0084×T_{F}−0.65×C(OH)+3422.2 (67)

T(zero-CTE)=44.27×C(TiO₂)+0.35×T_{F}+0.94×C(OH)−628.3 (68)

Similarly, Formulas (10), (11) and (14), Formulas (33), (35), and (37), and Formulas (58), (60) and (62) can be linearly combined to produce the following relational expressions for the soot-method TiO₂—SiO₂ glass (wherein C(TiO₂)=approximately 7 wt %, T_{F}=approximately 950 (=870+80)° C., and C(OH)=approximately 100 wtppm):

V_{L}=−26.26×C(TiO₂)+0.1188×T_{F}−0.70×C(OH)+5815.8+6.1+9.5 (69)

V_{LSAW}=−16.61×C(TiO₂)−0.0091×T_{F}−0.65×C(OH)+3422.2+5.6−0.7 (70)

T(zero-CTE)=44.27×C(TiO₂)+0.26×T_{F}+0.94×C(OH)−628.3−8.2+21.0 (71)

TiO₂ concentration C(TiO₂) is the most fundamental parameter that controls T(zero-CTE) of TiO₂—SiO₂ glass. OH concentration C(OH) is dependent on the fabrication process of TiO₂—SiO₂ glass. The TiO₂—SiO₂ glasses fabricated by the direct-synthesis method have OH concentrations C(OH) of approximately 500 to 2000 wtppm; TiO₂—SiO₂ glasses fabricated by the soot method have OH concentrations C(OH) of approximately 50 to 200 wtppm.

Fictive temperature T_{F} can be controlled by heat treatment. As the temperature increases above the strain point and approaches the annealing point, the structural relaxation time decreases and therefore the fictive temperature decreases below a holding temperature in the heat treatment, so that a large fictive temperature distribution occurs in the ingot. When the temperature is much lower than the strain point, manufacturing cost will be unfeasibly high because of long structure relaxation time. A controllable range of temperatures in the case of large ingots is within approximately ±100° C. around the strain point, which is one of the characteristic temperatures of glass.

Here, the coefficients represent the amount of change per 1 wt % for C(TiO₂), 1° C. for T_{F}, and 100 wtppm for C(OH). If T_{F} and C(OH) differ from the values given above, the coefficients in Formulas (66), (67), (68), (69), (70), and (71) will vary.

The results of experiments have shown the following resolutions of measurements:

C(TiO₂) can be measured with accuracies of ±0.02 wt % by the X-ray fluorescence analysis (XRF) method.

C(OH) can be measured with accuracies of ±0.1% (±1 wtppm) by the infrared spectroscopy method.

T_{F} can be measured with accuracies of ±0.4° C. by the longitudinal-wave velocity measurement.

Here, the influence of uncertainty of each of the parameters {C(TiO₂): ±0.02 wt %, T_{F}: ±0.4° C., and C(OH): ±1 wtppm} on T(zero-CTE) is as shown in Table 5 below.

TABLE 5
Influence of Uncertainty of C(TiO₂), T_{F} and C(OH) on T(zero-CTE)

| | Uncertainty |
|---|---|
| C(TiO₂) | ±0.89° C. |
| T_{F} | ±0.14° C. |
| C(OH) | ±0.01° C. |

Thus, the order of influences of C(TiO₂), T_{F} and C(OH) on T(zero-CTE) can be estimated to be C(TiO₂)>T_{F}>C(OH).

### [First Control Method]

T(zero-CTE) is adjusted to a desired value by changing C(TiO₂) while keeping C(OH)=C_{OH} and T_{F}=C_{Tf} constant.

T(zero-CTE)=f{C(TiO₂), C_{OH}, C_{Tf}}

AP=f{C(TiO₂), C_{OH}, C_{Tf}}

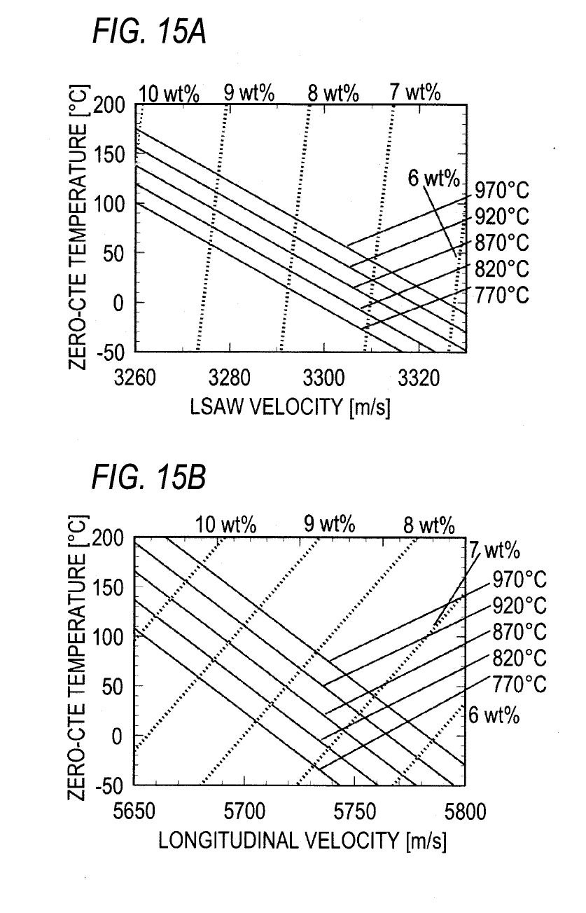

Here, the zero-CTE temperature and the acoustic properties are dependent only on C(TiO₂) and T(zero-CTE) can be evaluated from an acoustic property (for example V_{LSAW}). For example, a commercially available TiO₂—SiO₂ glass fabricated by the direct-synthesis method has a constant C(OH)=C_{OH}=1000 wtppm and a constant T_{F}=C_{Tf}=870° C. This glass has a strain point of 890° C. and T_{F} that is approximately 20° C. lower than the strain point. It is assumed here that properties of the commercially available TiO₂—SiO₂ glass (T_{F}=870° C. and C(OH)=1000 wtppm) are properties at the strain point. Here, the relationship between LSAW velocity and T(zero-CTE) can be represented by the solid line of T_{F}=870° C. in FIG. 15A and the relationship between longitudinal-wave velocity and T(zero-CTE) can be represented by the solid line of T_{F}=870° C. in FIG. 15B.

TiO₂ concentration can be controlled within the range of 0.05 to 9 wt %. When C(TiO₂) is 6 wt % and 9 wt %, T(zero-CTE) is −39° C. and 94° C., respectively. T(zero-CTE) can be controlled within the range of −39 to 94° C. by changing C(TiO₂).

In this case, since V_{LSAW} and V_{L} significantly change, T(zero-CTE) can be evaluated by measuring V_{LSAW} and V_{L}.

[Second Control Method]

T(zero-CTE) is adjusted to a desired value by changing T_{F} while keeping C(TiO₂)=C_{Ti} and C(OH)=C_{OH} constant.

T(zero-CTE)=f{C_{Ti}, C_{OH}T_{F},}

AP={C_{Ti}, C_{OH}, T_{F}}
T(zero-CTE) can be controlled using fictive temperature T_{F}.
Longitudinal-wave velocity V_{L} is highly sensitive to the fictive temperature T_{F} among the acoustic properties AP. Therefore, T_{F} can be determined by measuring V_{L} if C(TiO₂) and C(OH) can be measured by other methods (XRF method and FT-IR method). This method is useful for evaluating T(zero-CTE) which is related to changes in T_{F}.

For example, when a commercially available TiO₂—SiO₂ glass {C(TiO₂)=7 wt %, C(OH)=1000 wtppm} is subjected to heat treatment, T_{F} can be changed and T(zero-CTE), V_{LSAW} and V_{L} change along the lines of 7 wt % in FIGS. 15A and 15B. T(zero-CTE) increases as T_{F} increases.

T_{F} of a glass can be controlled within approximately ±100° C. around the strain point. When T_{F}=770° C., 870° C. and 970° C., T(zero-CTE) is −30° C., 5° C., and 40° C., respectively. Thus, T(zero-CTE) can be controlled in the range of −30° C. to 40° C.

The higher C(TiO₂) and T_{F}, the higher T(zero-CTE). When C(TiO₂)=9 wt % and T_{F}=970° C., T(zero-CTE) is 128° C.

[Third Control Method]

C(OH) is changed while keeping C(TiO₂)=C_{Ti} and T_{F}=C_{Tf} constant. A glass having a higher T(zero-CTE) can be obtained by a glass production process with a low C(OH).

T(zero-CTE)=f{C_{Ti}, C(OH), C_{Tf}}

ΔP=f{C_{Ti}, C(OH), C_{Tf}}
C(OH) is dependent on the production process of glass. A glass fabricated by the direct-synthesis method has C(OH) of approximately 500 to 2000 wtppm; a glass fabricated by the soot method has C(OH) of approximately 50 to 200 wtppm.
As shown in Table 5 given above, the influence of C(OH) on the acoustic properties and T(zero-CTE) is small.
The smaller C(OH), the higher a glass characteristic temperature (strain point). For example, SiO₂ glasses have glass characteristic temperatures as shown in Table 6 below.

TABLE 6
Relationship between OH Concentration and Glass
Characteristic Temperatures of SiO₂ glass

| OH concentration | Strain point | Annealing point | Softening point |
|---|---|---|---|
| [wtppm] | [° C.] | [° C.] | [° C.] |
| <10 (approximately 0) | 1110 | 1200 | 1720 |
| {Soot method | | | |
| (without water)} | | | |
| 100 {Soot method | 1050 | 1150 | 1720 |
| (with water) | | | |
| 1100 (Direct-synthesis | 970 | 1080 | 1720 |
| method) | | | |

Since T_{F}=C_{Tf} of glass can be controlled within approximately ±100° around the strain point, T_{F} can be increased by reducing C(OH). The higher T_{F}, the higher T(zero-CTE) and therefore the higher the upper limit of T(zero-CTE) becomes.
In the mass-production stage of EUVL, a material that has a high T(zero-CTE) is required because of high light-source power. In this case, a production process with a low C(OH) (the soot method) needs to be used for fabricating glass.
When C(OH)=100 wtppm {the soot method (with water) is assumed}, the strain point is 80 (1050-970)° C. higher than that in the direct-synthesis method.

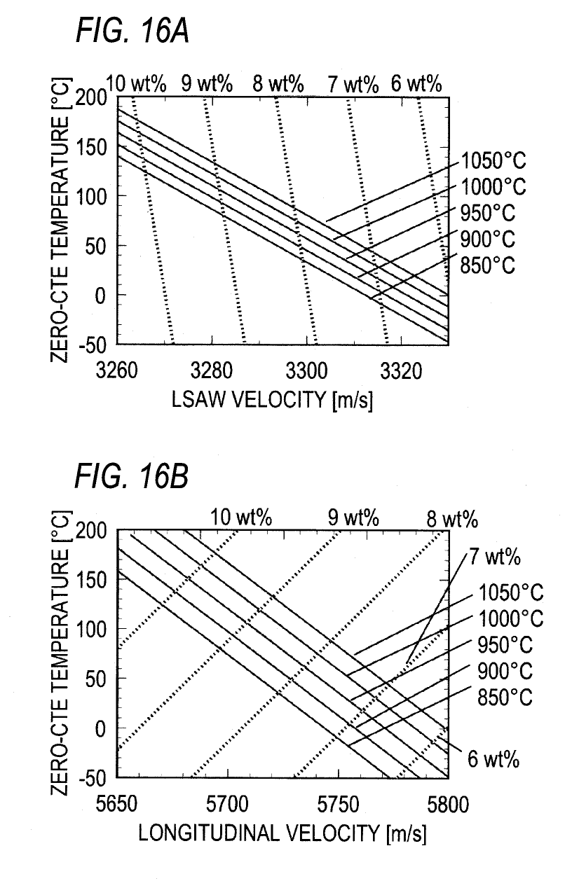

FIG. 16A shows a relationship between LSAW velocity and T(zero-CTE) of TiO₂—SiO₂, obtained for the soot method (C(OH)=approximately 100 wtppm) and FIG. 16B shows a relationship between longitudinal-wave velocity and T(zero-CTE). The relationships among fictive temperature, acoustic properties and zero-CTE temperature according to Formulas (33) to (38) are used.

The acoustic properties and the zero-CTE temperature can be obtained by using Formulas (69), (70) and (71) for a soot-method TiO₂—SiO₂ glass, that is, when C(TiO₂)=approximately 7 wt %, T_{F}=approximately 950 (=870+80)° C., and C(OH) is 100 wtppm.

When T_{F}=870° C., C(OH) changes from 1000 wtppm to 100 wtppm to decrease the zero-CTE temperature by 8.2° C.

Zero-CTE temperature at 950 (=870+80)° C. is 17° C. when C(TiO₂)=7 wt % and 106° C. when C(TiO₂)=9 wt %.

At 1050 (=950+100)° C., which is 100° C. higher than the strain point, the zero-CTE temperature is 133° C.
When C(OH)=0 wtppm {the soot method (without water) is assumed}, the strain point is 140 (1110-970)° C. higher than that in the direct-synthesis method.

The zero-CTE temperature decreases by 9.0° C. because C(OH) changes from 1000 wtppm to 0 wtppm at T_{F}=870° C.

Similarly, the relationships among the fictive temperature, the acoustic properties, and the zero-CTE temperature when C(OH)=0 wtppm can be obtained from calibration lines obtained for the direct-synthesis method (C(OH)=approximately 1000 wtppm) and the soot method (C(OH)=approximately 100 wtppm) as the following Formulas.

V_{L}=−26.26×C(TiO₂)+0.1171×T_{F}−0.70×C(OH)+5815.8+6.6+16.4 (72)

V_{LSAW}=−16.61×C(TiO₂)−0.0108×T_{F}−0.65×C(OH)+3422.2+6.1−1.5 (73)

T(zero-CTE)=44.27×C(TiO₂)+0.25×T_{F}+0.94×C(OH)−628.3−9.0+35.5 (74)

The zero-CTE temperature at the strain point 1010 (=870+140)° C. is 32° C. when C(TiO₂)=7 wt % and 120° C. when C(TiO₂)=9 wt %. The zero-CTE temperature is 145° C. at a temperature 100° C. higher than 1110 (=1010+100)° C.

From the foregoing:

TiO₂—SiO₂ ultra-low-expansion glasses having T(zero-CTE) in the range of −74° C. to 145° C. can be obtained at C(TiO₂) of 6 to 9 wt %, T_{F} of 770 to 1110° C., and C(OH) of 0 to 2000 wtppm.

[Production and Evaluation of Ultra-Low-Expansion Glass]

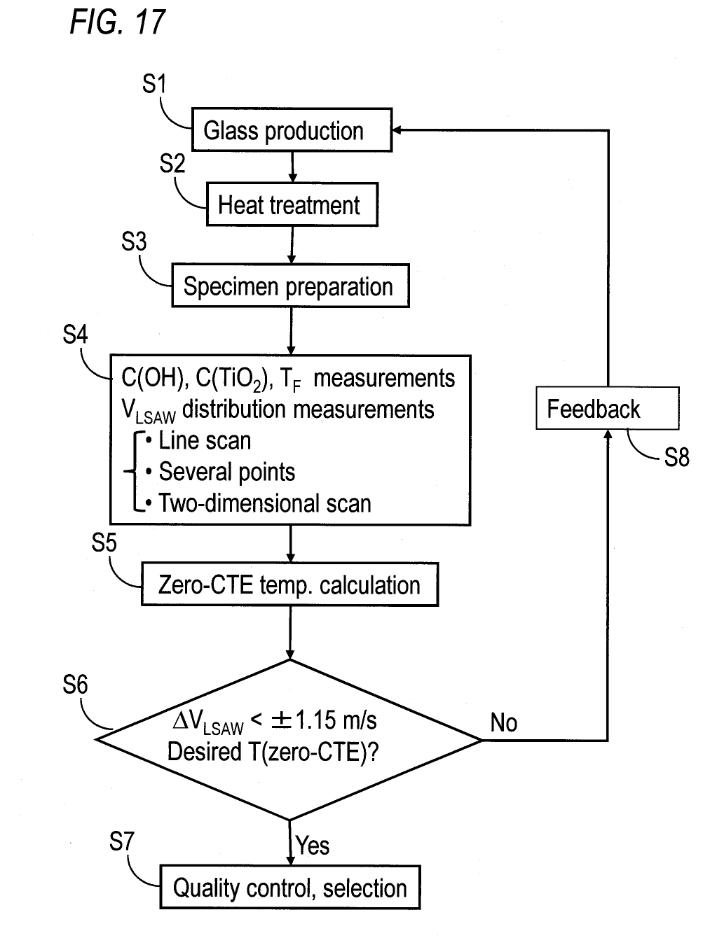

A procedure for evaluating and analyzing the zero-CTE temperature T(zero-CTE) of an ultra-low-expansion glass in a glass-development stage and in a mass-production stage will be described separately. FIG. 17 shows a flowchart of the evaluation and analysis.

The evaluation/analysis uses the fact that, as shown in Table 1 in FIG. 6, the LSAW velocity V_{LSAW} and the longitudinal-wave velocity V_{L} are highly sensitive to changes in T(zero-CTE) caused by changes in TiO₂ concentration and V_{L} is highly sensitive to changes in T(zero-CTE) caused by changes in fictive temperature T_{F} whereas V_{LSAW} has a low sensitivity to the changes in T(zero-CTE) temperature caused by changes in fictive temperature T_{F}.

In the development stage of glasses, the T(zero-CTE) of the produced glasses and the distributions of striae (primarily caused by changes in TiO₂ concentration) of the glass ingots need to be determined. In the mass-production stage of glass, on the other hand, glass manufacturers need to perform evaluation and selection of T(zero-CTE) of mirror substrates and photomask substrates for quality control of the produced glass ingots and in order to appropriately configure reflective optics of EUVL systems, provided that the striae problem has been alleviated and the level of striae is within an acceptable range (ΔV_{LSAW}<±1.15 m/s). The glass users also need to perform receiving inspection for checking to see whether glass materials have desired characteristics.

Glass Development Stage

Step S1: A TiO₂—SiO₂ glass ingot is fabricated under predetermined production process conditions. For a production method, whether to use the direct-synthesis method or the soot method, is decided depending on a required zero-CTE temperature range, for example.

Step S2: Heat treatment is performed under predetermined conditions. For example, a fictive temperature corresponding to a required zero-CTE temperature is decided to decide the heat treatment conditions.
Step S3: A sample for evaluation is provided from a glass ingot.
Step S4: C(OH), C(TiO₂) and T_{F} are measured. The C(OH) is measured typically with a Fourier-transform infrared spectroscopy (FT-IR) system. The C(TiO₂) is measured by V_{LSAW} or an XRF system. The T_{F} is measured by longitudinal-wave velocity V_{L} or an FT-IR system or a Raman spectroscopy system.

In order to evaluate the homogeneity of the glass, V_{LSAW} line-scanning measurement or measurement of two-dimensional distributions of V_{SLAW} is performed.

Step S5: The central value of T(zero-CTE) is calculated using calibration lines from the C(OH), C(TiO₂) and T_{F} measured at step S4. For example, T(zero-CTE) of a TiO₂—SiO₂ glass fabricated by the direct-synthesis method is calculated using the results of the measurements at step S4 according to Formula (68); T(zero-CTE) of a TiO₂—SiO₂ glass fabricated by the soot method is calculated according to Formula (71).
Step S6: Check to determine whether the difference ΔT between the calculated T(zero-CTE) and a target value is in a predetermined acceptable range and check to determine whether the V_{LSAW} distribution (ΔV_{LSAW}) measured at step S4 is within ±1.15 m/s corresponding to ΔCTE<±5 ppb/K. If both conditions are satisfied, the glass ingot can be used as an EUVL-grade glass at step S7. If either or both of the conditions are not satisfied, the process proceeds to step S8, where the result is fed back to the glass production process conditions.
Step S8: If ΔV_{LSAW} is ±1.15 m/s or more, the ΔV_{LSAW} is fed back to the glass production process conditions so that a more homogeneous ingot is fabricated. Specific production conditions for improving the homogeneity are not a subject matter of the present invention and therefore the description will be omitted. If the measured T(zero-CTE) is higher than a desired value by ΔT° C., for example, one of the three parameters, C(TiO₂), T_{F} and C(OH), which affect CTE, is changed while keeping the other two values fixed, so that the T(zero-CTE) decreases by ΔT. In that case, one of the three control methods described above can be used.

According to the first control method, in the case of a TiO₂—SiO₂ glass fabricated by the direct-synthesis method, for example, C(TiO₂) in Formula (68) is changed without changing the values of T_{F} and C(OH). Specifically, an instruction to change the TiO₂ concentration to decrease the value by ΔT/44.27 below the measured C(TiO₂) is fed back to step S1.

According to the second control method, an instruction to control the heat treatment at step S2 to decrease the fictive temperature T_{F} in Formula (68) by ΔT/0.35 without changing the values of C(TiO₂) and C(OH) is provided to step S1.

According to the third control method, an instruction to adjust the production conditions to decrease C(OH) by ΔT/0.94 without changing the values of C(TiO₂) and T_{F} is issued to step S1.

Fabrication of glasses by the direct-synthesis method has been described in the three examples given above. For a TiO₂—SiO₂ glass fabricated by the soot method, Formula (71) can be used to obtain feedback information in the same manner.

Glass Mass-Production Stage

As in the glass development stage, steps S1 to S3 of the glass development are performed.

Step S4: C(OH), C(TiO₂) and T_{F} are measured.

V_{LSAW} is measured at a plurality of points in a specimen surface or by line scanning.

Step S5: T(zero-CTE) is calculated using calibration lines from the C(OH), C(TiO₂) and T_{F} measured at step S4.
Step S6: Check the sample to determine whether the sample has a desired T(zero-CTE). Check to determine whether the V_{LSAW} distribution measured at step S4 is within ±1.15 m/s. If the V_{LSAW} distribution is within ±1.15 m/s, the glass ingot can be used as glass for EUVL. If the V_{LSAW} distribution is ±1.15 m/s or more, the result is fed back to glass production process conditions at step S8.
Step S7: The T(zero-CTE) obtained at step S5 is used to select the glass ingot for a desired application.

### REFERENCE LITERATURES

[1] K. M. Davis, A. Agarwal, M. Tomozawa, and K. Hirao, “Quantitative infrared spectroscopic measurement of hydroxyl concentrations in silica glass,” J. Non-Cryst. Solids, Vol. 203, pp. 27-36 (1996).
[2] H. A. Bowman, R. M. Schoonover, and M. W. Jones, “Procedure for high precision density determinations by hydrostatic weighing,” J. Res. Natl. Bur. Stand., Vol. 71C, pp. 179-198 (1967).
[3] M. Okaji, N. Yamada, and H. Moriyama, “Ultra-precise thermal expansion measurements of ceramic and steel gauge blocks with an interferometric dilatometer,” Metrologia, Vol. 37, pp. 165-171 (2000).
[4] R. Bruckner, “Properties and structure of vitreous silica. I,” J. Non-Cryst. Solids, Vol. 5, pp. 123-175 (1970).
[5] H. Kakiuchida, N. Shimodaira, E. H. Sekiya, K. Saito, and A. J. Ikushima, “Refractive index and density in F- and Cl-doped silica glasses,” Appl. Phys. Lett., Vol. 86, 161907 (2005).
[6] J. E. Shelby, “Density of vitreous silica,” J. Non-Cryst. Solids, Vol. 349, pp. 331-336 (2004).
[7] A. Agarwal, K. M. Davis, and M. Tomozawa, “A simple IR spectroscopic method for determining fictive temperature of silica glasses,” J. Non-Cryst. Solids, Vol. 185, pp. 191-198 (1995).
[8] A. E. Geissberger and F. L. Galeener, “Raman studies of vitreous SiO₂ versus fictive temperature,” Phys. Rev. B, Vol. 28, pp. 3266-3271 (1983).

1. An ultra-low-expansion glass production method comprising the steps of:
(a) fabricating a TiO₂—SiO₂ glass ingot having a selected TiO₂ concentration;
(b) cutting a sample from the TiO₂—SiO₂ glass ingot and measuring OH concentration C(OH), TiO₂ concentration C(TiO₂) and fictive temperature T_{F};
(c) calculating zero-CTE (coefficient of thermal expansion) temperature T(zero-CTE) from the measured C(OH), C(TiO₂) and T_{F};
(d) judging whether a difference ΔT between the T(zero-CTE) and a predetermined target value is within a predetermined acceptable range and, when the difference ΔT is within the acceptable range, judging that the TiO₂—SiO₂ glass ingot has a desired zero-CTE temperature; and
(e) when the difference ΔT is not within the acceptable range in the step (d), correcting a fabrication condition for the TiO₂—SiO₂ glass ingot on the basis of the difference ΔT from the target value.

2. The production method according to claim 1, wherein the measurement of the C(OH) in the step (b) is a measurement by infrared spectroscopy.

3. The production method according to claim 1, wherein the measurement of the C(TiO₂) in the step (b) is a measurement of leaky-surface-acoustic-wave velocity V_{LSAW} on the sample or measurement by X-ray fluorescence analysis.

4. The production method according to claim 1, wherein the measurement of the T_{F} in the step (b) measures corresponding longitudinal-wave velocity.

5. The production method according to any one of claims 1 to 4, wherein the step (c) performs the calculation according to a Formula T(zero-CTE)=aC(TiO₂)+bT_{F}+cC(OH)+d, where a, b, c and d are predetermined coefficients.

6. The production method according to claim 5, wherein the step (e) obtains ΔT/a from the difference ΔT and feeds back the ΔT/a as an amount of correction to C(TiO₂).

7. The production method according to claim 5, wherein the step (e) obtains ΔT/b from the difference ΔT and feeds back the ΔT/b as an amount of correction to T_{F}.

8. The production method according to claim 5, wherein the step (e) obtains ΔT/c from the difference ΔT and feeds back the ΔT/c as an amount of correction to C(OH).

9. The production method according to any one of claims 1 to 4, wherein the step (b) comprises the step of measuring a LSAW velocity distribution ΔV_{LSAW} on the sample, the step (d) comprises the step of judging whether the measured ΔV_{LSAW} is within a predetermined range and, when the measured ΔV_{LSAW} is not within the predetermined range, judging that the sample is unacceptable.

10. A TiO₂—SiO₂ glass fabricated in the production method according to claim 1 has a zero-CTE temperature T(zero-CTE) in the range of −74° C. to 145° C.

11. The TiO₂—SiO₂ glass according to claim 10 has a C(TiO₂) in the range of 0.05 wt % to 9 wt %.

12. The TiO₂—SiO₂ glass according to claim 11 has a C(TiO₂) in the range of 6 wt % to 9 wt %.

13. The TiO₂—SiO₂ glass according to claim 10 has a C(OH) in the range of 0 wtppm to 2000 wtppm.

14. The TiO₂—SiO₂ glass according to claim 10 has a T_{F} in the range of 770° C. to 1110° C.
